(19) United States
(12) Patent Application Publication
(10) Pub. No.: US 2026/0280358 A1
(43) Pub. Date: Sep. 17, 2026

(54) Data Communication Optimizations for Wireless Power Transfer Systems

(71) Applicant: Apple Inc., Cupertino, CA (US)

(72) Inventors: Girish V Varatkar, Sammamish, WA (US); Sriram Narayanan, Los Gatos, CA (US); Stephen C Terry, San Jose, CA (US)

(21) Appl. No.: 19/447,362

(22) Filed: Jan. 13, 2026

Related U.S. Application Data
(60) Provisional application No. 63/771,448, filed on Mar. 13, 2025.

(51) Int. Cl. H02J 50/80; H02J 50/10; H04L 27/04

(52) U.S. Cl. CPC H02J 50/80; H02J 50/10; H04L 27/04

(57) ABSTRACT

A power receiving device can include a wireless power transfer coil configured to receive wireless power from a power transmitting device via inductive coupling between the power transmitting and the power receiving device and can include a data communication transmitter configured to transmit data across the inductive coupling to the power transmitting device in accordance with an amplitude modulation scheme. Data transmission across the inductive coupling can experience variable gain corresponding to a signal frequency of the data transmission. Data transmission across the inductive coupling can be adjusted to accommodate the differences in gain.

### CROSS-REFERENCE TO RELATED APPLICATION

This application claims the benefit of U.S. provisional patent application No. 63/771,448, filed Mar. 13, 2025, which is hereby incorporated by reference herein in its entirety.

### FIELD

This relates generally to wireless power transfer systems, and, more particularly, to data communication optimizations in wireless power transfer systems.

### BACKGROUND

In a wireless power transfer system, a wireless power transmitting device wirelessly transmits power to a wireless power receiving device. The wireless power transmitting device has a coil and inverter circuitry for generating alternating current wireless power signals. The wireless power receiving device has a coil and rectifier circuitry for receiving and converting the wireless power signals to power one or more electrical loads. During wireless power transfer, the devices may communicate with one another for purposes such as power control. This data communication occurs via the wireless power signal(s) that are being transferred between the devices.

### SUMMARY

An aspect of the disclosure provides a power receiving device that includes a wireless power transfer coil configured to receive wireless power from a power transmitting device via inductive coupling between the power transmitting device and the power receiving device, a rectifier coupled to the wireless power transfer coil and configured to output a corresponding rectified voltage, and a data communication transmitter coupled to the wireless power transfer coil and configured to transmit data across the inductive coupling to the power transmitting device in accordance with an amplitude modulation scheme. Data transmission across the inductive coupling between the power transmitting device and the power receiving device experiences variable gain corresponding to a signal frequency of the data transmission; data representing ‘0’ data bits, when transmitted to the power transmitting device across the inductive coupling, experience a first amount of gain of the variable gain; and data representing ‘1’ data bits, when transmitted to the power transmitting device across the inductive coupling, experience a second amount of gain of the variable gain, different than the first amount of gain. The data communication transmitter is further configured to transmit data representing ‘0’ data bits using a first signal amplitude and to transmit data representing ‘1’ data bits using a second signal amplitude, different than the first signal amplitude, to compensate for a difference between the first amount of gain and the second amount of gain.

An aspect of the disclosure provides a method of operating a power receiving device that includes: with a wireless power transfer coil, receiving wireless power from a power transmitting device via inductive coupling between the power transmitting device and the power receiving device; with a rectifier coupled to the wireless power transfer coil, outputting a corresponding direct-current voltage; and with a data communication transmitter coupled to the wireless power transfer coil, transmitting data across the inductive coupling to the power transmitting device in accordance with an amplitude modulation scheme. Data transmission across the inductive coupling between the power transmitting device and the power receiving device experiences variable gain corresponding to a signal frequency of the data transmission; data representing ‘0’ data bits, when transmitted to the power transmitting device across the

inductive coupling, experience a first amount of gain of the variable gain; and data representing ‘1’ data bits, when transmitted to the power transmitting device across the inductive coupling, experience a second amount of gain of the variable gain, different than the first amount of gain. Transmitting data across the inductive coupling to the power transmitting device in accordance with the amplitude modulation scheme can include transmitting data representing ‘0’ data bits using a first signal amplitude and transmitting data representing ‘1’ data bits using a second signal amplitude, different than the first signal amplitude, to compensate for a difference between the first amount of gain and the second amount of gain.

An aspect of the disclosure provides control circuitry configured to be coupled to a wireless power transfer coil of a power receiving device, the control circuitry is further configured to receive data via inductive coupling from a power transmitting device and to transmit data via the inductive coupling to the power transmitting device in accordance with an amplitude modulation scheme. Data transmission across the inductive coupling between the power transmitting device and the power receiving device experiences variable gain corresponding to a signal frequency of the data transmission; data representing ‘0’ data bits, when transmitted to the power transmitting device across the inductive coupling, experience a first amount of gain of the variable gain; data representing ‘1’ data bits, when transmitted to the power transmitting device across the inductive coupling, experience a second amount of gain of the variable gain, different than the first amount of gain; data representing ‘0’ data bits are transmitted to the power transmitting device across the inductive coupling using a first signal amplitude; and data representing ‘1’ data bits are transmitted to the power transmitting device across the inductive coupling using a second signal amplitude greater than the first signal amplitude.

### BRIEF DESCRIPTION OF THE DRAWINGS

FIG. 1 is a schematic diagram of an illustrative wireless power transfer system that includes a power transmitting device and a power receiving device in accordance with some embodiments.

FIG. 2 is a circuit diagram of wireless power transmitting and receiving circuitry in accordance with some embodiments.

FIG. 3 is a timing diagram of an illustrative data bit encoding scheme in accordance with some embodiments.

FIG. 4 is a diagram of an illustrative variable gain response of an inductive channel of a wireless power transfer system in accordance with some embodiments.

FIG. 5 is a diagram showing transmission of ‘0’ data bits and ‘1’ data bits using different signal amplitudes in accordance with some embodiments.

FIG. 6 is a diagram showing transmission of ‘0’ data bits and ‘1’ data bits” using different reference levels in accordance with some embodiments.

FIG. 7 is a diagram showing transmission of ‘0’ data bits using at least three different signal levels in accordance with some embodiments.

FIG. 8 is a diagram showing transmission of ‘1’ data bits using at least four different signal levels in accordance with some embodiments.

FIG. 9 is a flowchart of illustrative techniques for operating a wireless power transfer system of the type shown in accordance with FIGS. 1-8 in some embodiments.

FIG. 10 is a flowchart of illustrative techniques for operating a wireless power transfer system of the type shown in accordance with FIGS. 1-8 in some embodiments.

FIG. 11 is a flowchart of illustrative techniques for operating a wireless power transfer system of the type shown in accordance with FIGS. 1-8 in some embodiments.

### DETAILED DESCRIPTION

A wireless power transfer system, sometimes referred to as a wireless power transmission system or wireless charging system, includes a power transmitting device and a power receiving device. The power transmitting device (“PTX”) can transmit wireless power to the power receiving device (“PRX”). Examples of power transmitting devices include electronic devices such as wireless charging mats or pucks that couple to power adapters or other power source (such as by way of cables), battery packs, or more generally, other electronic devices with wireless power transmitting circuitry. A power receiving device can use the wireless power received from a power transmitting device for powering internal components and/or for charging an internal battery. Wireless power transfer operations are sometimes referred to as wireless power transmission operations or wireless charging operations. Examples of power receiving devices include electronic devices such as cellular telephones, tablet computers, laptop computers, ear buds, battery cases for ear buds and other devices, tablet computer styluses (pencils) and other input-output devices, wearable devices, wristwatches, head-mounted devices, glasses, and so forth.

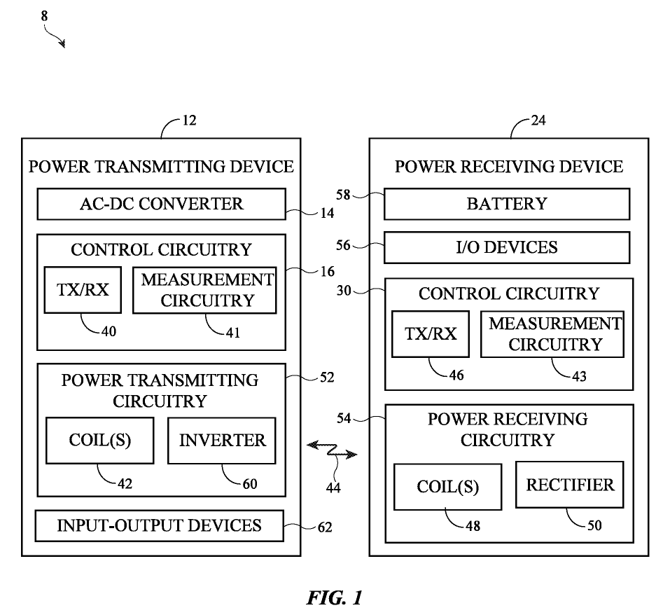

An illustrative wireless power transfer system 8 is shown in FIG. 1. As shown in FIG. 1, system 8 includes a PTX such as power transmitting device 12 and includes a PRX such as power receiving device 24. Power transmitting device 12 can include control circuitry 16, whereas power receiving device 24 can include control circuitry 30. Example control circuitries 16 and 30 control the operation of system 8. These control circuitries 16 and 18 may include processing circuitry associated with microprocessors, power management units, baseband processors (e.g., a Bluetooth processing module, a near field communication or NFC controller, etc.), application processors, central processing units (CPUs), digital signal processors, microcontrollers, application-specific integrated circuits, and/or other processing circuitry.

The control circuitries 16 and 30 implement desired control and communications features in devices 12 and 24. For example, control circuitries 16 and 30 may be used in determining power transmission levels, processing sensor data and other data, handling negotiations between devices 12 and 24, sending and receiving in-band and out-of-band data, making measurements, and otherwise controlling the operation of system 8. The control circuitries in system 8 can use one or more of hardware (e.g., dedicated hardware or circuitry), firmware and/or software in performing operations. Firmware and/or software code may be stored on non-transitory computer readable storage media (e.g., tangible computer readable storage media), which may be updated from time to time. The firmware and/or software code may sometimes be referred to as software, program instructions, instructions, or code. The non-transitory computer readable storage media may include non-volatile memory such as non-volatile random-access memory (NVRAM), solid state storage, flash drives, or the like. Firmware and software stored on the non-transitory computer readable storage media may be executed on the processing circuitry of control circuitry 16 and/or 30.

Power transmitting device 12 may be coupled to a wall outlet (e.g., an alternating current power source), may have a battery for supplying power, and/or may have another source of power. Power transmitting device 12 may have an alternating-current (AC) to direct-current (DC) power converter such as AC-DC power converter 14 for converting AC power from a wall outlet or other power source into DC power. In some configurations, AC-DC power converter 14 may be provided in an enclosure (e.g., a power brick enclosure) that is separate from the enclosure of device 12 (e.g., a wireless charging puck enclosure or battery-powered electronic device enclosure) and a cable may be used to couple DC power from the power converter to device 12. DC power may be used to power control circuitry 16.

As shown in FIG. 1, power transmitting device 12 also includes power transmitting circuitry 52. Power transmitting circuitry 52 may include switching circuitry, such as inverter 60 formed from transistor switches) that turn on and off, to create AC current signals that are provided to one or more wireless power transfer coils 42. Power transmitting device 12 can have one or more coils 42 depending on the implementation. In single-coil implementations, a single inverter 60 may drive a single coil 42. In multi-coil implementations, one or more inverters 60 may drive a plurality of coils 42. Multiple coils 42 may be arranged in a planar coil array (e.g., in configurations in which power transmitting device 12 is a wireless charging mat) or may be arranged to form a cluster of coils (e.g., in configurations in which power transmitting device 12 is a wireless charging puck).

During operation, control circuitry 16 works with power transmitting circuitry 52, such as by controlling the switching and timing sequence of inverter 60, to generate AC signals that are appropriate for wireless power transfer, to transmit wireless power to power receiving device 24. As AC current signals pass through one or more coils 42, the coils 42 produce corresponding electromagnetic field 44 in response to the AC current signals. Electromagnetic field 44 is sometimes referred to as wireless power or wireless power signals. The wireless power signals 44 can then induce a corresponding AC current to flow in one or more nearby receiver coils such as coil 48 of power receiving device 24. The induced current is provided to rectifier 50. Rectifier 50 includes transistor switches organized to convert the AC current into a DC output. In some implementations, rectifier 50 is a synchronous rectification bridge network, and the AC-to-DC converted current is used to power one or more loads in power receiving device 24. Examples of loads include I/O devices 56, battery 58, control circuitry 30, and other computing components (not shown in FIG. 1) such as application processors, other processing circuits, displays, and so forth.

Control circuitry 16 in power transmitting device 12 can include measurement circuitry 41, which comprises signal detection and signal measurement circuitries that facilitate feedback control of wireless power transfer system 8. For example, measurement circuitry 41 can be configured to detect external objects on the charging surface of the housing of device 12, and can facilitate the detection of whether a detected object is compatible with the wireless power transfer system. Measurement circuitry 41 can also measure or derive operating characteristics such as voltages and currents that are input to and output from the various power stages of power transmitting device 12. For example, measurement circuitry 41 can assess how much power is being drawn from AC-DC converter 14 and how much power is being output by inverter 60. Measurement circuitry 41 can also detect the presence of one or more foreign objects, such as paper clips, keys, or other metallic objects, to which wireless power transfer should be avoided.

Similarly, control circuitry 30 in power receiving device 24 includes measurement circuitry 43, which comprises signal detection and signal measurement circuitries that also facilitate feedback control of wireless power transfer system 8. For example, measurement circuitry 43 can be configured to monitor how much power is provided by rectifier 50 so that system 8 can account for the efficiency of power transfer between devices 12 and 24. Examples of other operating conditions that may be measured and/or derived using measurement circuitries 41 and 43 include coil quality (Q) factor measurements, coil inductance measurements, coupling coefficient measurements, operating temperatures, and so forth. Using this information, control circuitries 16 and/or 30 can characterize the operation of devices 12 and 24.

Control circuitry 16 in power transmitting device 12 also includes wireless data communication transceiver (TX/RX) circuitry 40, whereas control circuitry 30 in power receiving device 24 includes wireless data communication transceiver (TX/RX) 46. Transceiver circuitry 40 can use coil(s) 42 to transmit data communication signals to transceiver circuitry 46 using coil(s) 48. Suitable modulation schemes may support data communication between power transmitting device 12 and power receiving device 24. For example, in the Qi standard promulgated by the Wireless Power Consortium (WPC), a power transmitting device uses frequency-shift keying (FSK) modulation of its inverter output signal to convey in-band data to a power receiving device. The Qi standard also specifies that a power receiving device uses amplitude-shift keying (ASK) to convey in-band data to a power transmitting device. These data signals, which are conveyed using the wireless power signals 44, are referred to as “in-band” data communication signals. In other implementations, “out-of-band” channels such as NFC and/or Bluetooth may be used.

During wireless power transfer operations, power transmitting circuitry 52 supplies AC current signals to one or more coils 42 at a given wireless power transmission frequency, sometimes referred to herein as an “operating frequency.” Devices operating under the Qi wireless power transfer standard established by the Wireless Power Consortium generally operate between 110-205 kHz and/or at specific frequencies such as 360 kHz. Other operating frequencies are possible, with certain implementations at, for example 128 kHz, 326 kHz, 1.78 MHz, 13.56 MHz, and so forth. As a further example, the Power Matters Alliance (PMA) wireless charging standard operates between 277-357 kHz. In some implementations, the operating frequency is negotiated during startup communication between devices 12 and 24. In some implementations, the operating frequency can vary during a power transfer session. In other implementations, the operating frequency is fixed. Power transmitting device 12 may transfer wireless power to power receiving device 24 in accordance with one or more wireless charging standards, including the WPC and/or PMA examples above. If desired, other wireless charging interface definitions can be implemented, including proprietary protocols.

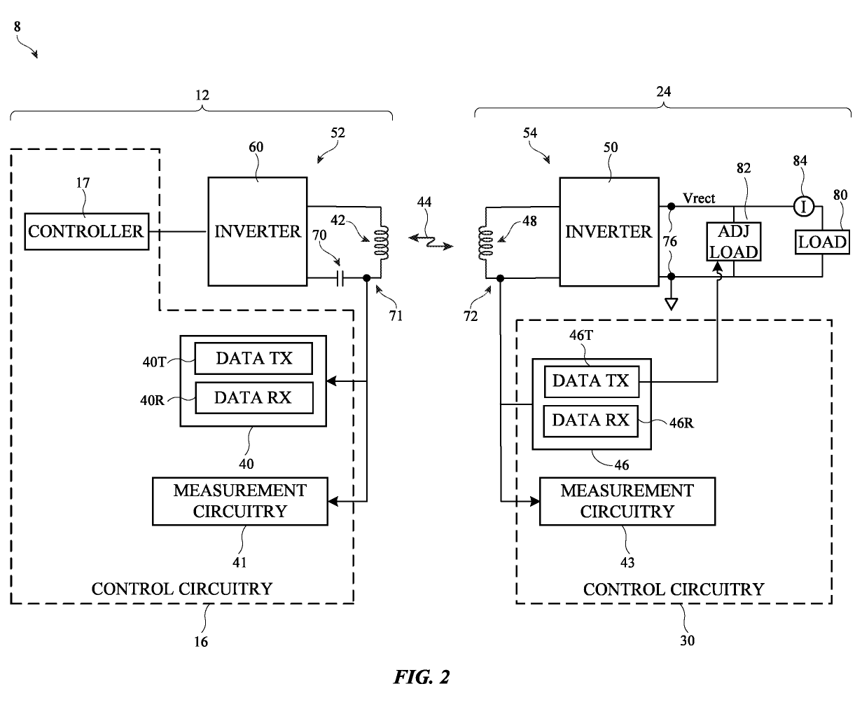

FIG. 2 is a circuit diagram of devices 12 and 24 in accordance with some embodiments. As shown in FIG. 2, control circuitry 16 of device 12 can include transceiver circuitry 40, measurement circuitry 41, and a controller 17. Controller 17 can be configured to provide a supply voltage for powering inverter 60. Controller 17 can also be configured to provide control signals to a control input of inverter 60. Inverter 60 can be configured to output AC drive signals onto wireless power transfer coil 42. A single coil 42 is shown in the example of FIG. 2, but multiple coils 42 may be used, if desired. Wireless power transfer coil 42 can be coupled in series with a capacitor 70. Transceiver circuitry 40 may include a data communication transmitter (TX) 40T and a data communication receiver (RX) 40R. As an example, transmitter 40T can be an FSK modulator and receiver 40R can be an ASK demodulator. This is merely illustrative. If desired, transmitter 40T and receiver 40R can modulate and demodulate data using other modulation schemes. Data communication receiver 40R can have an input coupled to a node 71 disposed between capacitor 70 and coil 42. Measurement circuitry 41 can have an input coupled to node 71. Such connections are illustrative. If desired, transceiver circuitry 40 and/or measurement circuitry 41 can have inputs coupled to other nodes within power transmitting circuitry 52.

At power receiving device 24, control circuitry 30 can include transceiver circuity 46 and measurement circuitry 43. Transceiver circuitry 46 may include a data communication transmitter (TX) 46T and a data communication receiver (RX) 46R. As an example, transmitter 46T can be an ASK modulator and receiver 46R can be an FSK demodulator. This is merely illustrative. If desired, transmitter 46T and receiver 46R can modulate and demodulate data using other modulation schemes. Wireless power transfer coil 48 can be coupled to inputs of rectifier 50. Rectifier 50 can have output terminals 76 at which a rectified DC voltage Vrect is produced. The rectified voltage Vrect can be provided to a load 80 for powering load 80 (e.g., for charging battery 58, for powering a display and/or other input-output devices 56, and/or for powering other circuitry in load 80). Transceiver 46T can be coupled to wireless power transfer coil 48 (e.g., at node 72). Measurement circuitry 43 can have an input also coupled to wireless power transfer coil 48 at node 72. Such connections are illustrative. If desired, transceiver circuitry 46 and/or measurement circuitry 43 can be coupled to other nodes within power receiving circuitry 54.

The output terminals 76 of rectifier 76 are also coupled to an adjustable load 82. Adjustable load 82 is sometimes referred to as a ballast load, adjustable ballast load, or adjustable current load. As an example, adjustable load 82 can be implemented using one or more ballast transistor(s). Adjustable load 82 is used to help ensure that there is always a minimum current flowing between output terminals 76, even if the components in load 80 have not yet been activated (e.g., during start-up). For example, adjustable load 82 may be adjusted to draw a predetermined current (e.g., 50 mA) when power receiving device 24 initially receives power (e.g., before the battery charging circuitry for battery 58, the display, and/or other input-output devices 56 of load 80 start to draw significant current).

A current sensor 84 may be used to detect current flow through load 80. When it is determined that current is flowing to load 80 (e.g., when battery 58 is being charged and/or other load components such as a display, communications circuitry, control circuitry, and other components are drawing current), control circuitry 30 of power receiving device 24 can apply a control signal to a control (gate) terminal of adjustable load 82 that turns adjustable load 82 off or otherwise reduces the current flow through adjustable load 82 (e.g., to reduce undesired power consumption due to current flow through adjustable load 82). Operated in this way, adjustable load 82 serves as a ballast that helps to ensure sufficient loading is present during modes of operation in which load 80 is not drawing significant current. Adjustable load 82 draws current when load 80 is inactive and is not drawing current. When load 80 is active and is drawing current, adjustable load 81 is turned off or is otherwise adjusted to draw less current than when load 80 is inactive.

In accordance with an embodiment, the magnitude of the voltage (and, if desired, the phase of the voltage) on node 71 in device 12 can be modulated by modulating the amount of current passing through adjustable load 82 (e.g., by using transmitter 46T to control one or more ballast transistors within adjustable load 82). In other words, adjustable load 82 can dynamically vary an amount of current being drawn at output terminals 76 of rectifier 50 such that the impedance of coil 48 seen by power transmitting circuitry 52 of device 12 is varied accordingly. This, in turn, modulates the input impedance of power transmitting circuitry 52, which modulates the flow of wireless power signals 44 from coil 42 to coil 48 and thereby modulates the magnitude of the voltage (and, if desired, the phase of the voltage) of the signal at node 71 in device 12. Thus, adjustable load 82 can serve dual purposes in power receiving device 24 – e.g., to help with: 1) load ballasting and 2) modulating load current to transmit in-band data. This dual use of adjustable load 82 can be technically advantageous to reduce hardware costs.

The example above in which adjustable load 82 is configured to draw or sink current is illustrative. In other embodiments, adjustable load 82 can include one or more capacitors. In such embodiments, the one or more capacitors within adjustable load 82 can be selectively switched in and out of use to modulate the flow of wireless power signals 44 from coil 42 to coil 48, which modulates the magnitude of the voltage of the signal at node 71 in device 12 (e.g., the capacitors can be selectively activated and deactivated to transmit ‘0’ and ‘1’ data bits at different signal amplitudes). In yet other embodiments, one or more capacitors can be selectively coupled to and decoupled from coil 48, using data communication transmitter 46T, to transmit in-band data to device 12.

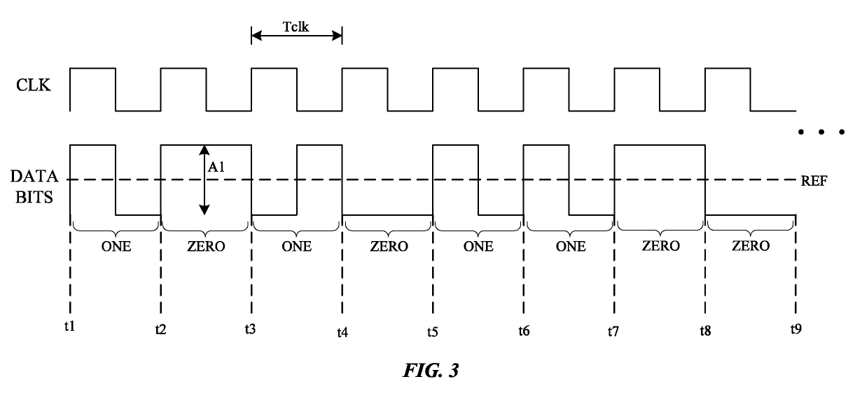

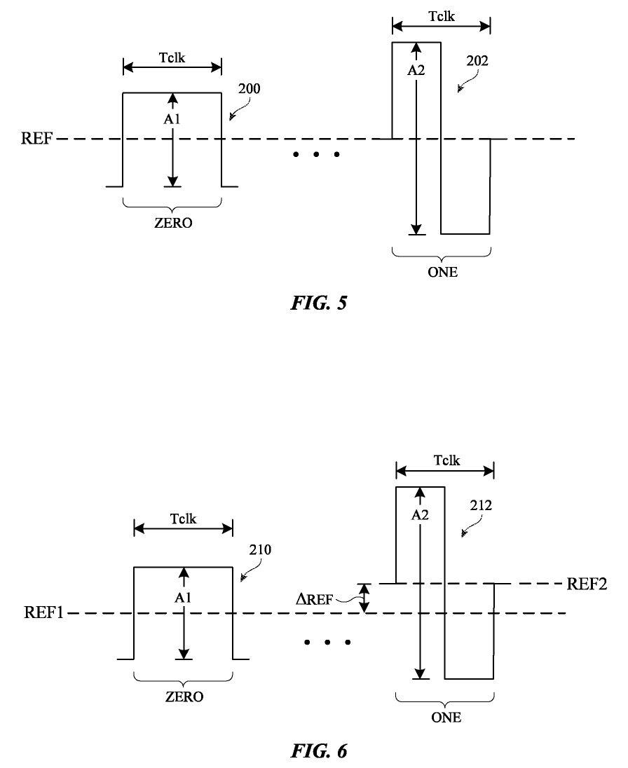

In accordance with some embodiments, data transmitter 46T (e.g., an ASK modulator) of power receiving device 24 is configured to transmit ASK data bits using a data bit encoding scheme of the type shown in FIG. 3. As shown in FIG. 3, successive data bits can be transmitted using an associated clock signal CLK. Such clock signal CLK can be fed as an input signal to data transmitter 46T. Clock signal CLK, sometimes referred to as an ASK transmit clock signal, can have a clock period Tclk that is equal to a reciprocal of the frequency of signal CLK. In particular, ‘one’ (e.g., high or ‘1’) data bits can be encoded by having a signal transition (e.g., either from high to low as shown between times t1 and t2 or from low to high as shown between times t3 and t4) in the middle of a clock period. In contrast, ‘zero’ (e.g., low or ‘0’) data bits can be encoded by having no signal transition in the middle of a clock period. As an example of a ‘0’ data bit, the signal can either remain high for the entirety of the clock period (e.g., from time t2 to t3) or can remain low for the entirety of the clock period (e.g., from time t4 to t5). The data bit signal waveform shown in FIG. 3 can represent a differential signal waveform. The data bits can be transmitted at a signal amplitude A1 about a signal reference level REF. Here, amplitude A1 refers to the peak-to-peak swing that is centered around level REF. The example of FIG. 3 illustrates a scenario where ‘0’ bits and ‘1’ bits are transmitted using the same signal amplitude A1. As described in more detail below in connection with the embodiments of FIGS. 5 and 6, the signal amplitude of ASK bits transmitted from device 24 to device 12 can be varied depending on the type of data bits being transmitted.

Such type of data encoding scheme for modulating data bits can be referred to and defined herein as a differential “bi-phase encoding” scheme. This example in which the bi-phase encoding scheme encodes ‘one’ bits using a signal transition in the middle of a clock period while encoding ‘zero’ bits using a lack of signal transition within a clock period is illustrative. Alternatively, an encoding scheme that encodes ‘one’ bits using no signal transition within a clock period while encoding ‘zero’ bits using a signal transition in the middle of a clock period can be implemented. Device configurations in which data bits are transmitted using the bi-phase encoding scheme as shown in FIG. 3 are sometimes described herein as an example. In the bi-phase encoding scheme, ‘0’ data bits are transmitted at a first pulse width (equal to period Tclk), where ‘1’ data bits are transmitted at a second pulse width (half of Tclk) less than the first pulse width. Operated as such, the encoding of ‘1’ data bits, which have a smaller pulse width, would appear as a signal of higher frequency relative to the ‘0’ data bits, which have a wider pulse width. In particular, the data bit toggling frequency of the signal associated with the encoding of ‘1’ data bits can be equal to double (e.g., two times) the frequency of the signal associated with the encoding of ‘0’ data bits. Operated as such, the ‘0’ data bits can be transmitted at a first communication data rate (equal to f0), whereas the ‘1’ data bits can be transmitted at a second communication data rate (equal to f1) greater than the first communication data rate.

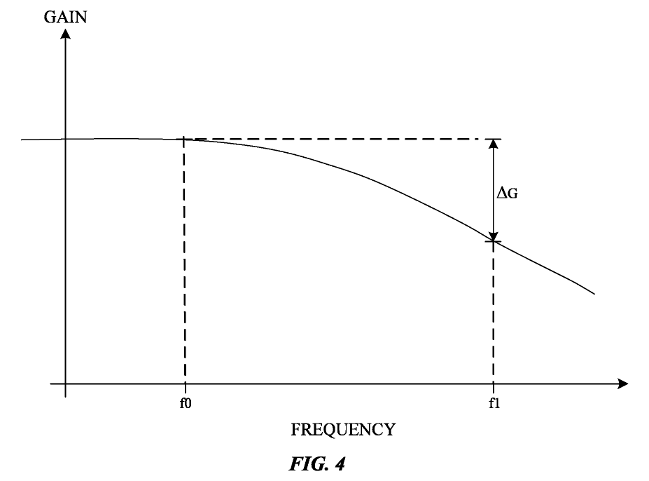

Data transmission signals can be conveyed wirelessly between devices 12 and 24 via inductive coupling. For example, in-band FSK data bits can be conveyed from device 12 to device 24 using coils 36 and 48 while in-band ASK data bits can be conveyed from device 24 to device 12 using coils 48 and 36 in the reverse direction. The inductive coupling, sometimes referred to herein as an inductive channel, of the wireless power transfer system can experience or exhibit a variable gain as a function of the frequency of a signal that is communicated through the inductive coupling. FIG. 4 is a diagram of an illustrative variable gain response of the inductive coupling of wireless power transfer system 8. The gain of the inductive coupling of system 8 is sometimes referred to herein as channel gain. In the example of FIG. 4, at lower frequencies such as for frequencies smaller than frequency f0, the gain response is relatively flat. At higher frequencies such as for frequencies above frequency f0, the gain response may roll off with noticeable gain degradation as frequency increases towards and beyond frequency f1. In other words, data transmission across the inductive coupling between devices 12 and 24 can experience variable gain corresponding to a signal frequency of the data transmission.

Consider the example in which the frequency of the signal associated with ‘1’ data bits is represented by frequency f1 and the frequency of the signal with ‘0’ data bits is represented by frequency f0. That is, frequency f1 is equal to 2*f0. As shown in FIG. 4, the amount of signal gain at frequency f0 and the amount of signal gain at frequency f1 can have a gain difference ∆G. In other words, the ‘0’ data bits transmitted across the inductive coupling experience a first, higher, amount of gain, whereas the ‘1’ data bits transmitted across the inductive coupling experience a second amount of gain less than the first amount of gain. This gain difference ∆G results in a relatively higher signal-to-noise ratio for some data bits (e.g., ‘0’ bits) and lower signal-to-noise ratio for other data bits (e.g., ‘1’ bits).

In implementations involving higher data transmission rates, this challenge of variable gain is exacerbated by the absolute value of the gain difference ∆G. Consider, in a system where clock signal CLK (FIG. 3) driving data communication is 2 kHz, the frequency difference between transmission of ‘0’ and ‘1’ data bits (e.g., f0 and f1 respectively) can be 1 kHz as seen by the inductive coupling. In contrast, in a faster system where clock signal CLK is 20 kHz, the frequency difference (e.g., between f0 and f1) can be upwards of 10 kHz. As the gain difference ∆G experienced by a signal across the inductive coupling increases with the difference in frequency, the latter (faster) system would experience more gain drop off as compared with the former (slower) system as frequencies f0 and f1 increase in value.

In accordance with an embodiment, the gain differences leading to inconsistent signal-to-noise ratio (SNR) is mitigated by transmitting data bits of a first type of modulation (e.g., ‘0’ data bits) using a first signal amplitude while transmitting data bits of a second type of modulation (e.g., the ‘1’ data bits) using a second signal amplitude, different than the first signal amplitude, to compensate for the difference between the first amount of gain associated with the first type of data bits and the second amount of gain associated with the second type of data bits across the inductive coupling between devices 24 and 12. In certain implementations, such as the example above, ‘0’ data bits which have a lower frequency as seen by the inductive coupling are transmitted with a lower gain, and ‘1’ data bits which have a relatively higher frequency as seen by the inductive coupling are transmitted with a relatively higher signal amplitude to compensate for the difference in channel gain. Extending more generally, data bits that are represented by a lower frequency modulation are transmitted with a relatively lower signal amplitude to normalize the overall signal envelope as seen by the wireless power transfer device that is receiving and/or decoding the data bits.

FIG. 5 is a diagram showing an example of how ‘0’ data bits and ‘1’ data bits can be transmitted using different signal amplitudes in accordance with some embodiments. As shown by waveform 200, data representing ‘0’ data bits may be transmitted using a first signal amplitude A1 about a signal reference level REF. Waveform 200 can also be inverted for representing other ‘0’ data bits. In contrast, as shown by waveform 202 in FIG. 5, data representing ‘1’ data bits may be transmitted using a second signal amplitude A2 about signal reference level REF. In the illustrated example, waveform 202 includes a falling edge within a CLK period (see FIG. 3) to signal a ‘1’ data bit. Waveform 202 can also be inverted, such that it includes a rising edge, for representing other ‘1’ data bits. The signal amplitude A2 of waveform 202 may be greater than the signal amplitude A1 of waveform 200 to compensate for the lower inductive coupling gain associated with the transmission of ‘1’ bits. This technique of transmitting ‘1’ data bits with greater signal amplitude relative to ‘0’ data bits can be called amplitude modulation pre-emphasis. The difference in signal amplitude in waveforms 200 and 202 can be achieved by adjusting the amount of current drawn by current load 82 (FIG. 2).

FIG. 6 shows another example of amplitude modulation pre-emphasis where ‘0’ data bits and ‘1’ data bits are transmitted about different signal reference levels. As shown, example waveform 210 representing a ‘0’ data bit may be transmitted using a first signal amplitude A1 about a first signal reference level REF1 (e.g., waveform 210 may be a differential signal that toggles about level REF1). Waveform 210 can also be inverted for representing other ‘0’ data bits. In contrast, as shown by waveform 212 in FIG. 6, data representing ‘1’ data bits may be transmitted using a second signal amplitude A2 about a second signal reference level REF2 that is different than REF1 (e.g., waveform 212 may be a differential signal that toggles about level REF2). Waveform 212 can also be inverted for representing other ‘1’ data bits.

In the example of FIG. 6, the second signal reference level REF2 may be greater than the first signal reference level REF1 by a reference offset ∆REF. Such reference levels are illustrative. Alternatively, second signal reference level REF2 may be less than first signal reference level REF1 by an offset. Additionally, the signal amplitude A2 of waveform 212 can optionally be greater than the signal amplitude A1 of waveform 210 to compensate for the lower inductive coupling gain associated with the transmission of ‘1’ bits. The difference in signal amplitude in waveforms 210 and 212 can be achieved by adjusting the amount of current drawn by current load 82.

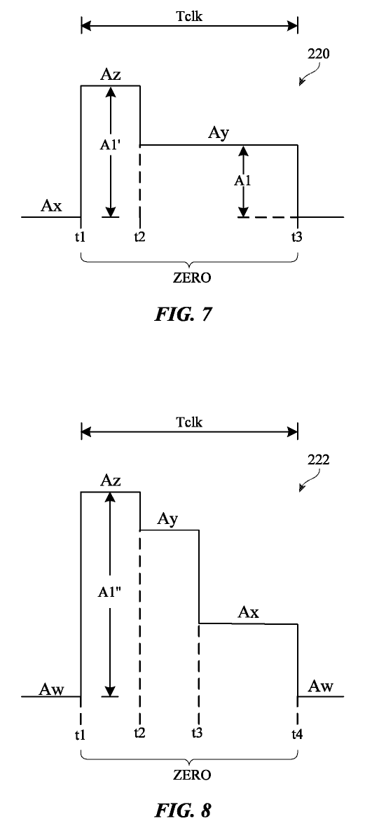

The examples of FIGS. 5 and 6 in which ‘0’ data bits toggle between only two different signal levels with a total amplitude A1 are illustrative. FIG. 7 is a diagram showing how data representing ‘0’ data bits can be transmitted using at least three different signal levels in accordance with some embodiments. As shown in FIG. 7, waveform 220 can be raised from signal level Ax to a signal level Az at time t1. At time t2, waveform 220 can then be lowered from signal level Az to signal level Ay. At time t3, waveform 220 can then be lowered from signal level Ay back down to signal level Ax. The signal amplitude A1’ between signal levels Ax and Az may be greater than the signal amplitude A1 between signal levels Ax and Ay (e.g., the initial signal transition from Ax to Az produces a signal amplitude A1’ greater than amplitude A1). Due to the bandwidth-limiting nature of the inductive coupling, even when the signal output from data transmitter 46T has the waveform shown in FIG. 7, the signal received at data receiver 40R will appear like waveform 200 as shown in FIG. 5 representing a ‘0’ data bit. In other words, the falling edge of waveform 220 at time t2 would not sufficiently register as a falling edge transition suggestive of a ‘1’ data bit. Temporarily overdriving waveform 220 to an elevated signal level Az at the beginning of clock period Tclk can help improve the channel response for the transmission of the ‘0’ bits (e.g., by improving the rise time of the signal transition to provide faster data settling). Waveform 220 can also be inverted for representing transmission of other ‘0’ data bits.

The example of FIG. 7 in which ‘0’ data bits can be driven to at least three different signal levels Ax, Ay, and Az is merely illustrative. FIG. 8 is a diagram showing another example in which data representing ‘0’ data bits is transmitted using at least four different signal levels. As shown in FIG. 8, waveform 222 can be raised from signal level Aw to a signal level Az at time t1. At time t2, waveform 222 can then be lowered from signal level Az to signal level Ay. At time t3, waveform 222 can then be lowered from signal level Ay to signal level Ax. At time t4, waveform 222 can then be lowered from signal level Ax back down to signal level Aw. The signal amplitude A1’’ between signal levels Aw and Az may be greater than the signal amplitude A1 show in FIGS. 5 or FIG. 6 (e.g., the initial signal transition from Aw to Az produces a signal amplitude A1’’ greater than amplitude A1). Due to the bandwidth-limiting nature of the inductive coupling, even when the signal output from data transmitter 46T has the waveform shown in FIG. 8, the signal received at data receiver 40R will appear like waveform 200 as shown in FIG. 5 representing a ‘0’ data bit. In other words, the falling edges of waveform 222 at times t2 and t3 would not sufficiently register as a falling edge transition suggestive of a ‘1’ data bit. Temporarily overdriving waveform 222 to an elevated signal level Az at the beginning of clock period Tclk can help improve the channel response for the transmission of the ‘0’ bits (e.g., by improving the rise time of the initial signal transition to provide faster data settling). Waveform 222 can also be inverted for representing transmission of other ‘0’ data bits. The example of FIG. 8 in which ‘0’ data bits can be driven to at least four different signal levels Aw, Ax, Ay, and Az is merely illustrative. In general, each ‘0’ data bit can be driven to two or more different signal levels, three or more different signal levels, four or more different signal levels, etc.

The examples of FIGS. 7 and 8 in which ‘0’ data bits can be initially overdriven to achieve faster data settling are illustrative. If desired, ‘1’ data bits can similarly be overdriven at signal transitions to help achieve faster data settling.

In an ecosystem with multiple models of PTX and multiple models of PRX, scaling factors may be maintained by the PTXs and/or PRXs to assist in wireless power transfer operations. These ecosystem scaling factors may be exchanged between the PTX and PRX in a coupled transmitter-receiver pair, for example, to adjust runtime parameters to account for differences in behaviors of various types of PTXs and PRXs that may interoperate with one another, including the amount and/or type of transmit pre-emphasis to employ in data communications.

Exemplary ecosystem scaling techniques are described in Applicant’s U.S. Patent Application No. 17/681,363, entitled “Wireless Power Systems with Shared Inducive Loss Scaling Factors,” filed Feb. 25, 2022, now published as U.S. Patent Publication No. 2022/0320911 on Oct. 6, 2022, which is incorporated by reference herein in its entirety. Certain teachings of the publication are relied on below to clarify that ecosystem scaling techniques can operate in conjunction with amplitude modulation pre-emphasis of data communications across an inductively coupled channel.

In a wireless power transfer ecosystem with numerous different PTXs and PRXs, each pairing between a given one of the PTXs and a given one of the PRXs will result in potentially different set of magnetic properties, including inductive channel properties, thereby affecting the channel gain characteristics in an inductively coupled transmitter-receiver pair. To facilitate accurate transmitter and receiver data communications, the magnetic power loss parameters associated with PTXs and PRXs can be determined using measurements between various models of PTX and PRX and reference units (e.g., reference PTXs and reference PRXs).

Measurement circuitries 41 and 43 of FIGS. 1 and 2 can obtain measurements that are processed to extract coefficients or other parameters that characterize the gain characteristics of an inductively coupled channel between devices 12 and 24 and that are dependent on the magnetic properties of devices 12 and 24). These measurements and/or extracted quantities may be stored within each device and may be exchanged between devices so that device 24 (and, if desired, device 12) may use this information in determining the amount of data communication transmit pre-emphasis to apply. This information may also be used by device 24 and/or device 12 in determining what type of transmit pre-emphasis, including those discussed with reference to FIGS. 5-8, to use for data communication during wireless power transfer operations.

If, as an example, a model I power transmitting device and model J power receiving device are paired, the gain characteristics in the inductive coupling between the devices may differ from that experienced when these devices are paired with other models of devices. Coefficient scaling factors are optionally use to account for these variations.

To determine a baseline channel gain, the gain characteristics between a reference power transmitting device and a reference power receiving device are measured and/or extracted based on measured values. For example, the reference power receiving device can transmit a signal of known frequency and amplitude which is then measured, when received, by the reference power transmitting device. A series of these signals with variations in frequency and, optionally amplitude, can help characterize the inductive coupling between the devices. This process can be repeated for a power transmitting device of model I that is inductively coupled with the reference power receiving device. To the extent that there are differences in the gain characteristics of such a system relative to baseline (as experienced by the reference devices), one or more coefficients ⍺ can be calculated that normalizes the behavior of the model I power transmitting device relative to the baseline power transmitting device. This process also can be repeated for a power receiving device of model J that is inductively coupled with the reference power transmitting device. To the extent that there are differences in the gain characteristics of such a system relative to baseline, one or more coefficients β can be calculated that normalizes the behavior of the model J power receiving device relative to the baseline power receiving device. In this way, when model I and model J devices operate in the field, by exchanging coefficients ⍺ and β, they can optimize the amount and/or type of transmit pre-emphasis to apply for data communications, as a data transmitter in this scenario could determine, based on ⍺ and/or β, how much pre-emphasis to apply relative to a known reference baseline.

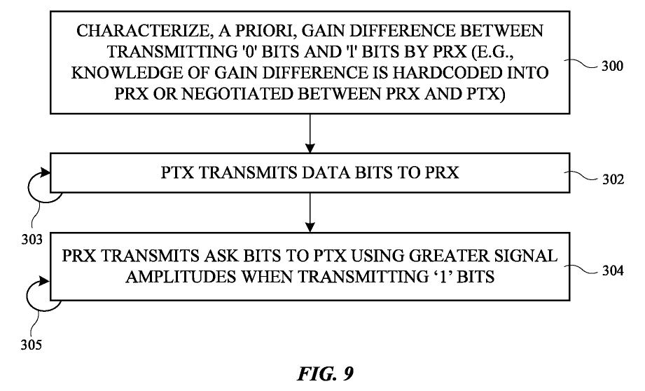

FIG. 9 is a flowchart of an illustrative technique for operating a wireless power transfer system 8. During block 300, the inductive coupling gain difference ∆G (see FIG. 4) between the transmission of ‘0’ data bits and the transmission of ‘1’ data bits by power receiving device 24 is characterized (calibrated), a priori, before wireless power transfer operations by a user of device 24. For example, a power receiving device 24 can be configured, in a factory, laboratory, or other controlled environment to transmit, using ASK modulation, a test pattern to a reference power transmitting device 12. The test pattern can include one or more ‘0’ data bits and one or more ‘1’ data bits. The reference power transmitting device 12 can be configured to measure an average signal strength, an average power, or other signal metric during transmission of the test pattern. For example, the reference power transmitting device 12 can compare the average power of signals received during transmission of the ‘0’ data bits to the average power of signals received during transmission of the ‘1’ data bits to determine an amount of gain difference ∆G. Gain difference ∆G computed in this way can be used to determine a default value of amplitude compensation (e.g., default amplitude values for amplitudes A1 and A2 as shown in FIGS. 5 or FIG. 6) for transmitting ‘0’ data bits and ‘1’ data bits during ASK communication. The operations of block 300 are sometimes referred to as calibration operations. These default amplitude values obtained via calibration can be hardcoded into device 24. This example in which the amplitude compensation values are hardcoded into device 24 is illustrative. Alternatively, various scaling factors (e.g., ecosystem scaling factors that account for differences in gain characteristics in the inductive coupling between various models of PTX and PRX) can be exchanged between devices 12 and 24 during negotiation operations. Such scaling factors exchanged between devices 12 and 24 can include a pre-characterized gain difference ∆G, may include information that can be used to calculate gain difference ∆G, or may include information that can be used to calculate the amplitude compensation values for compensating gain difference ∆G.

During wireless power transfer operations, devices 12 and 24 can perform in-band communications to exchange data packets. Power transmitting device 12 can transmit data bits (e.g., FSK data bits, ASK data bits, or data bits modulated using other types of modulation schemes) to power receiving device 24, as shown by the operations of block 302. In the reverse direction, power receiving device 24 can transmit ASK data bits to power transmitting device 12, as shown by the operations of block 304. During block 304, power receiving device 24 will transmit ASK bits in accordance with the hardcoded amplitude compensation values or based on the ecosystem scaling factors exchanged between devices 12 and 24. For example, device 24 will transmit ‘0’ bits using a first signal amplitude and will transmit ‘1’ bits using a second signal amplitude that is greater than the first signal amplitude to compensate for gain difference ∆G. Although block 304 is shown as occurring after block 302, the operations of block 304 can occur before or concurrently with the operations of block 302. The operations of block 302 can be repeated any number of times to convey data bits from device 12 to device 24 during wireless power transfer operations, as shown by arrow 303. The operations of block 304 can be repeated any number of times to convey ASK bits from device 24 to device 12 during wireless power transfer operations, as shown by arrow 305.

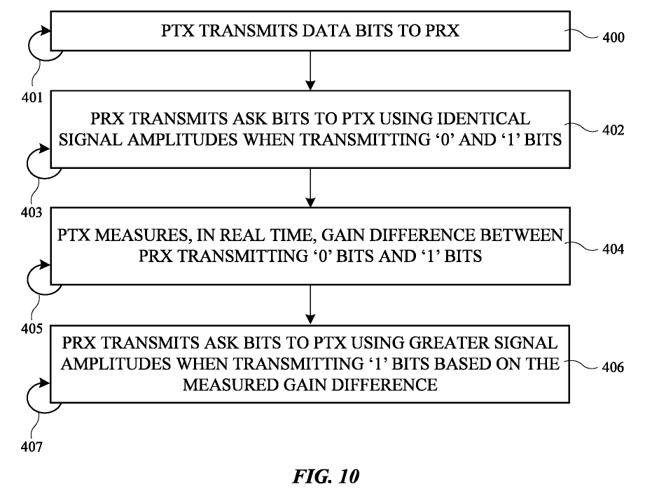

The technique of FIG. 9 for which amplitude compensation values are obtained prior to wireless power transfer is illustrative. FIG. 10 is a flowchart of another illustrative technique for operating wireless power transfer system 8. During wireless power transfer operations, devices 12 and 24 can perform in-band communications to exchange data packets. Power transmitting device 12 can transmit data bits (e.g., FSK data bits, ASK data bits, or data bits modulated using other types of modulation schemes) to power receiving device 24, as shown by the operations of block 400.

In the reverse direction, power receiving device 24 can transmit ASK data bits to power transmitting device 12, as shown by the operations of block 402. During block 402, power receiving device 24 will transmit ASK bits without any amplitude pre-emphasis (e.g., ‘0’ bits and ‘1’ bits will be transmitted using the same signal amplitude). Although block 402 is shown as occurring after block 400, the operations of block 402 can occur before or concurrently with the operations of block 400. The operations of block 400 can be repeated any number of times to convey data bits from device 12 to device 24 during wireless power transfer operations, as shown by arrow 401. The operations of block 402 can be repeated any number of times to convey ASK bits from device 24 to device 12 during wireless power transfer operations, as shown by arrow 403.

During the operations of block 404, power transmitting device 12 can be configured to measure, in real time, gain difference ∆G by comparing the average signal strength, the average power, or other signal metric between the transmission of ‘0’ data bits and the transmission of ‘1’ data bits. For example, device 12 may detect, using ASK demodulator 40R of FIG. 2, measurement circuitry 41 of FIG. 1, and/or other signal sensor in control circuitry 16, a first average signal strength during the transmission of ‘0’ data bits and a second average signal strength during the transmission of ‘1’ data bits. Gain difference ∆G can then be computed based on a difference between the first average signal strength and the second average signal strength. Such information can then be transmitted, via in-band communication, back to power receiving device 24. In general, gain difference ∆G can be computed at device 12 or at device 24. The operations of block 404 can be performed periodically or as needed during wireless power transfer, as indicated by arrow 405.

During the operations of block 406, power receiving device 24 can transmit ASK bits to device 12 based on the measurements gathered during block 404. For instance, power receiving device 24 can then perform the requisite amplitude modulation pre-emphasis to compensate for the detected gain difference ∆G. As an example, device 24 can increase or otherwise adjust the second signal amplitude A2 relative to the first signal amplitude A1 to compensate for gain difference ∆G. Alternatively or additionally, device 24 can decrease or otherwise adjust the first signal amplitude A1 relative to the second signal amplitude A2 to compensate for gain difference ∆G. Performing ASK modulation in this way can be technically advantageous and beneficial to help ensure that the average signal or power level of ‘0’ data bits are matched to the average signal or power level of ‘1’ data bits during high data rate in-band communications. In other words, the gain compensation can cause amplitude modulated signal peaks being received by power transmitting device 12 to be more consistent between ‘0’ data bits and ‘1’ data bits, relative to transmission of ‘0’ data bits and ‘1’ data bits using the same amount of gain. The operations of block 406 can be repeated any number of times to convey ASK bits from device 24 to device 12 during wireless power transfer operations, as shown by arrow 407. The operations of block 406 can be performed concurrently with the operations of block 402.

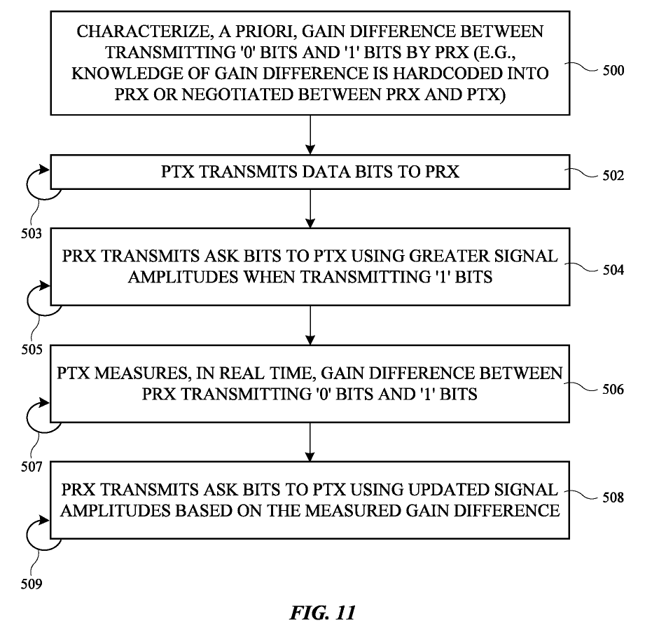

The techniques of FIGS. 9 and 10 are exemplary. FIG. 11 shows a hybrid approach in which the techniques of FIGS. 9 and 10 are combined. Block 500 of FIG. 11 is similar to block 300 of FIG. 9. Block 502 of FIG. 11 is similar to block 302 of FIG. 9. Block 504 of FIG. 11 is similar to block 304 of FIG. 9. Although block 504 is shown as occurring after block 502, the operations of block 504 can occur before or concurrently with the operations of block 502. The operations of block 502 can be repeated any number of times to convey data bits from device 12 to device 24 during wireless power transfer operations, as shown by arrow 503. The operations of block 504 can be repeated any number of times to convey ASK bits from device 24 to device 12 during wireless power transfer operations, as shown by arrow 505.

Some time after block 504, the operations of block 506 can be performed. Block 506 of FIG. 11 is similar to block 404 of FIG. 10. The operations of block 506 can be performed periodically or as needed during wireless power transfer, as indicated by arrow 507. Block 508 of FIG. 11 is similar to block 406 of FIG. 10. The operations of block 508 can be repeated any number of times to convey ASK bits from device 24 to device 12 during wireless power transfer operations, as shown by arrow 509. The operations of block 508 can be performed concurrently with the operations of block 502.

The techniques of FIG. 11 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

The foregoing is merely illustrative and various modifications can be made to the described embodiments. The foregoing embodiments may be implemented individually or in any combination.

What is claimed is:

1. A power receiving device comprising:
a wireless power transfer coil configured to receive wireless power from a power transmitting device via inductive coupling between the power transmitting device and the power receiving device;
a rectifier coupled to the wireless power transfer coil and configured to output a corresponding rectified voltage; and
a data communication transmitter coupled to the wireless power transfer coil and configured to transmit data across the inductive coupling to the power transmitting device in accordance with an amplitude modulation scheme,
wherein data transmission across the inductive coupling between the power transmitting device and the power receiving device experiences variable gain corresponding to a signal frequency of the data transmission,
wherein data representing ‘0’ data bits, when transmitted to the power transmitting device across the inductive coupling, experience a first amount of gain of the variable gain, and
wherein data representing ‘1’ data bits, when transmitted to the power transmitting device across the inductive coupling, experience a second amount of gain of the variable gain, different than the first amount of gain, the data communication transmitter is further configured to:
transmit data representing ‘0’ data bits using a first signal amplitude; and
transmit data representing ‘1’ data bits using a second signal amplitude, different than the first signal amplitude, to compensate for a difference between the first amount of gain and the second amount of gain.

2. The power receiving device of claim 1, wherein the data communication transmitter is further configured to transmit data bits in accordance with a differential bi-phase encoding scheme.

3. The power receiving device of claim 1, wherein the data communication transmitter is further configured to transmit data representing ‘0’ data bits with a first pulse width and transmit data representing ‘1’ data bits with a second pulse width less than the first pulse width.

4. The power receiving device of claim 1, wherein the data communication transmitter is further configured to transmit data representing ‘1’ data bits using the second signal amplitude to compensate for the difference between the first amount of gain and the second amount of gain so as to cause amplitude modulated signal peaks received by the power transmitting device to be more consistent between ‘0’ data bits and ‘1’ data bits, relative to transmission of data representing ‘0’ and ‘1’ data bits using a same amount of gain.

5. The power receiving device of claim 1, wherein the first and second signal amplitudes comprise default amplitude values obtained via calibration, and wherein the default amplitude values are hardcoded into the power receiving device.

6. The power receiving device of claim 1, further comprising:
a data communication receiver coupled to the wireless power transfer coil and configured to receive data across the inductive coupling from the power transmitting device, wherein the received data comprises scaling factors representing a behavior of the power transmitting device relative to a reference device, and wherein the first and second signal amplitudes are controlled based on the scaling factors.

7. The power receiving device of claim 1, further comprising:
a data communication receiver coupled to the wireless power transfer coil and configured to receive data across the inductive coupling from the power transmitting device, wherein the received data comprises measurement information, gathered by the power transmitting device, that is used to compute the first and second signal amplitudes at the power receiving device.

8. The power receiving device of claim 1, wherein the data communication transmitter is further configured to:
transmit data representing ‘0’ data bits by toggling signals with the first signal amplitude about a reference level; and
transmit data representing ‘1’ data bits by toggling signals with the second signal amplitude about the reference level, wherein the second signal amplitude is greater than the first signal.

9. The power receiving device of claim 1, wherein the data communication transmitter is further configured to:
transmit data representing ‘0’ data bits by toggling signals with the first signal amplitude about first a reference level; and
transmit data representing ‘1’ data bits by toggling signals with the second signal amplitude toggling about a second reference level different than the first reference level.

10. The power receiving device of claim 1, wherein the data communication transmitter is further configured to transmit data representing ‘0’ data bits by driving each ‘0’ data bit to at least three different signal levels, and wherein an initial signal level of the at least three different signal levels exhibits a signal amplitude greater than the first signal amplitude.

11. The power receiving device of claim 1, further comprising:
an adjustable load coupled to an output of the rectifier, wherein the adjustable load comprises a current load or one or more capacitors, and wherein the adjustable load is configured to operate in:
a first state so that the data communication transmitter transmits data representing ‘0’ data bits using the first signal amplitude; and
a second state, different than the first state, so that the data communication transmitter transmits data representing ‘1’ data bits using the second signal amplitude.

12. A method of operating a power receiving device, comprising:
with a wireless power transfer coil, receiving wireless power from a power transmitting device via inductive coupling between the power transmitting device and the power receiving device;
with a rectifier coupled to the wireless power transfer coil, outputting a corresponding direct-current voltage; and
with a data communication transmitter coupled to the wireless power transfer coil, transmitting data across the inductive coupling to the power transmitting device in accordance with an amplitude modulation scheme,
wherein data transmission across the inductive coupling between the power transmitting device and the power receiving device experiences variable gain corresponding to a signal frequency of the data transmission,
wherein data representing ‘0’ data bits, when transmitted to the power transmitting device across the inductive coupling, experience a first amount of gain of the variable gain,
wherein data representing ‘1’ data bits, when transmitted to the power transmitting device across the inductive coupling, experience a second amount of gain of the variable gain, different than the first amount of gain, and
wherein transmitting data across the inductive coupling to the power transmitting device in accordance with the amplitude modulation scheme comprises:
transmitting data representing ‘0’ data bits using a first signal amplitude; and
transmitting data representing ‘1’ data bits using a second signal amplitude, different than the first signal amplitude, to compensate for a difference between the first amount of gain and the second amount of gain.

13. The method of claim 12, wherein:
transmitting data representing ‘0’ data bits comprises outputting signals with the first amplitude and a first pulse width; and
transmitting data representing ‘1’ data bits comprises outputting signals with the second amplitude greater than the first amplitude and a second pulse width less than the first pulse width.

14. The method of claim 12, further comprising:
with a data communication receiver coupled to the wireless power transfer coil, receiving data across the inductive coupling from the power transmitting device in accordance with a frequency modulation scheme, wherein the received data comprises information for controlling the first and second signal amplitudes to compensate for the difference between the first amount of gain and the second amount of gain so as to cause amplitude modulated signal peaks received by the power transmitting device to be more consistent between ‘0’ data bits and ‘1’ data bits, relative to transmission of data representing ‘0’ and ‘1’ data bits using the same amount of gain.

15. The method of claim 12, wherein:
transmitting data representing ‘0’ data bits comprises toggling signals with the first signal amplitude about a reference level; and
transmitting data representing ‘1’ data bits comprises toggling signals with the second signal amplitude about the reference level.

16. The method of claim 12, wherein:
transmitting data representing ‘0’ data bits comprises toggling signals with the first signal amplitude about a first reference level; and
transmitting data representing ‘1’ data bits comprises toggling signals with the second signal amplitude about a second reference level different than the first reference level.

17. The method of claim 12, wherein transmitting data representing ‘0’ data bits comprises driving each ‘0’ data bit to three or more different signal levels to reduce data settling time, and wherein an initial signal level of the three or more different signal levels exhibits a signal amplitude greater than the first signal amplitude.

18. The method of claim 12, further comprising:
with an adjustable ballast load coupled to an output of the rectifier, drawing a first amount of current so that the data communication transmitter transmits data representing ‘0’ data bits using the first signal amplitude and drawing a second amount of current, different than the first amount of current, so that the data communication transmitter transmits data representing ‘1’ data bits using the second signal amplitude.

19. Control circuitry configured to be coupled to a wireless power transfer coil of a power receiving device, the control circuitry is further configured to:
receive data via inductive coupling from a power transmitting device; and
transmit data via the inductive coupling to the power transmitting device in accordance with an amplitude modulation scheme,
wherein data transmission across the inductive coupling between the power transmitting device and the power receiving device experiences variable gain corresponding to a signal frequency of the data transmission,
wherein data representing ‘0’ data bits, when transmitted to the power transmitting device across the inductive coupling, experience a first amount of gain of the variable gain,
wherein data representing ‘1’ data bits, when transmitted to the power transmitting device across the inductive coupling, experience a second amount of gain of the variable gain, different than the first amount of gain,
wherein data representing ‘0’ data bits are transmitted to the power transmitting device across the inductive coupling using a first signal amplitude, and
wherein data representing ‘1’ data bits are transmitted to the power transmitting device across the inductive coupling using a second signal amplitude greater than the first signal amplitude.

20. The control circuitry of claim 19 is further configured to:
transmit data representing ‘0’ data bits to the power transmitting device across the inductive coupling at a first communication data rate of equal to or greater than 10 kHz; and
transmit data representing ‘1’ data bits to the power transmitting device across the inductive coupling at a second communication data rate equal to two times the first communication data rate.
